(19) United States
(12) Patent Application Publication
(10) Pub. No.: US 2002/0175936 A1
(43) Pub. Date: Nov. 28, 2002

(54) Method for gauging user intention to review/replay the contents of a web page

(76) Inventor: Samuel Sergio Tenembaum, (US)

Correspondence Address: SAMUEL SERGIO TENEMBAUM, c/o UNITED VIRTUALITIES, INC., SUITE 500, 116 WEST 23rd STREET, NEW YORK, NY, 10011, US

(21) Appl. No.: 10/139,286

(22) Filed: May 7, 2002

Related U.S. Application Data
(60) Provisional application No. 60/289,359, filed on May 8, 2001.

(51) Int. Cl. G09G 5/00

(52) U.S. Cl. 345/738; 345/700

(57) ABSTRACT

The present invention consists of a method applicable to determine whether a person surfing the web and who has been subjected to a certain content is trying to see it again.

This information is valuable to a number of professional players, such as advertising agencies, advertisers, sites, marketers and researchers attempting to understand the behavior of users surfing the web. Moreover, conclusions secured from this information can be integrated into metrics utilized to measure the success of advertising and marketing initiatives only.

This application claims the benefit of U.S. Provisional Application No. 60/289,359 filed in the U.S. Patent and Trademark Office on May 8, 2001; the entire contents of the aforementioned Provisional Application being hereby incorporated by reference.

### BACKGROUND OF THE INVENTION

The present invention relates generally to a method used to determine whether a person surfing the web and who has been subjected to a certain content is trying to see it again.

This information is of value to advertising agencies, advertisers, sites, marketers and researchers attempting to understand the behavior of users surfing the web. Additionally, this information can be incorporated into metrics utilized to gauge the success of advertising and marketing initiatives only.

### BRIEF SUMMARY OF THE INVENTION

As the Internet emerges as a medium of mass communication, a plethora of business model has sprung in an attempt to make profits. From fee based services, to advertising supported ones and thousands of variations, which have already been launched or are yet to come.

Regardless of the chosen model, it is always desirable to understand the intentions, needs and behavior of users participating and accessing those services.

One of the behaviors or actions that are found across all models is when users instruct their web browsers to re-render whatever content is being displayed in their browsers. So much so, that all browsers currently in the market share a feature called “refresh” or “reload”. This feature off-loads and re-loads the current HTML document, executing the code contained in it from scratch. This feature is useful in a number of situations ranging from content delivery problems, buggy code, or when the content is such that develops over time, and the user want to reset it.

It is in this last case, that recording the “replay” intention is of value to content providers. Or in the case of advertising which develops over time (like a TV spot), it is useful to note when the target audience chooses to view an ad.

As important as this action is, web browsers do not recognize it as an event. When the Refresh/reload button is pressed, the browser simply off-loads and uploads the web page, it does not record the process in any way.

Due to the manner in which browsers operate, certain navigational routes can be confused with those occasions in which the user intentionally reloads a page. The distinction between a navigational turn—the itinerary of web pages viewed by a given user—and the intent to replay an event can be used to gauge the effectiveness of copy, creative execution, or any content which develops in time (i.e: which changes, and therefore may be reset and reviewed).

Unfortunately, when a user presses the reload/refresh button all that happens is that the page gets unloaded and reloaded. The RELOAD/REFRESH action is not registered as such.

In order to account for this function we have defined a method, which is used to infer a RELOAD or REFRESH event, the inferred event is called an ENCORE.

An ENCORE can be defined as follows:

Those occasions in which an unique user requests the same page consecutively within a certain given time frame.

### BRIEF DESCRIPTION OF THE DRAWINGS

To fully understand this definition and the technical issues it overcomes it is important to understand how browsers operate.

When a browser loads a page, among the data it stores and considers are two fields containing the URL of the current page [a] and another URL called the referrer [b], which is the web address of the page containing the link, which led to the current page.

FIG. 1 depicts a web page (101) linking to a second web page (201), in both cases A indicates the URL of the current page and B indicates the referrer URL. It should be noted that in the case of a page, which was not linked to but requested through a Bookmark or Favorite, or by typing its URL directly into the browser, the referrer field might be empty.

FIG. 2 depicts such a situation, wherein A indicates the current URL and B is empty. The preferred embodiment of the present invention takes the current URL and the referrer URL as data points for determining if a refresh/reload has taken place. A refresh/reload can be referred to as an ENCORE and such can be defined as the loading of a page in which the referrer matches the current URL.

FIG. 3 depicts such an occasion. Block 301 represents a starting web page, block 302 represents the ENCORE event, block 303 represents the same web page after being reloaded/refreshed. Note that in block 303, the current URL A and referrer URL are the same.

The problem with this definition is that the referrer field does not concern the previous page viewed, but the page containing the link aiming at the current one, if such page exists.

So the pressing of the REFRESH/RELOAD button does NOT result on the previous graphic but on FIG. 4.

FIG. 4 depicts an originating web page on block 401, a refresh/reload action on block 402, and a resulting web page on block 403.

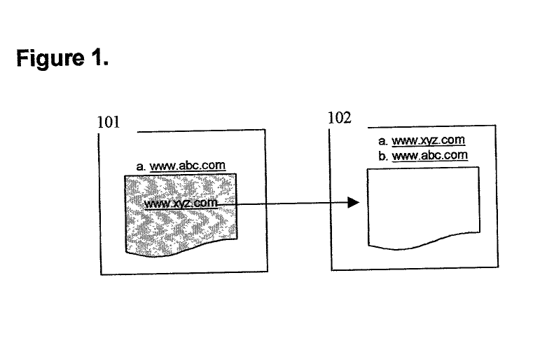

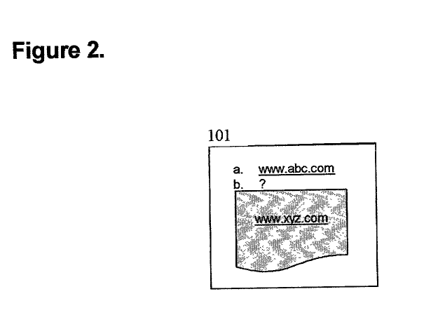

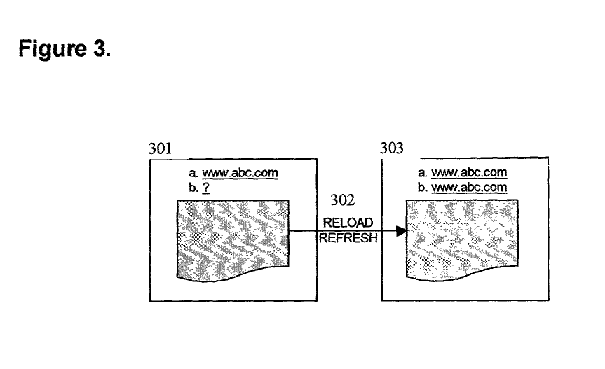

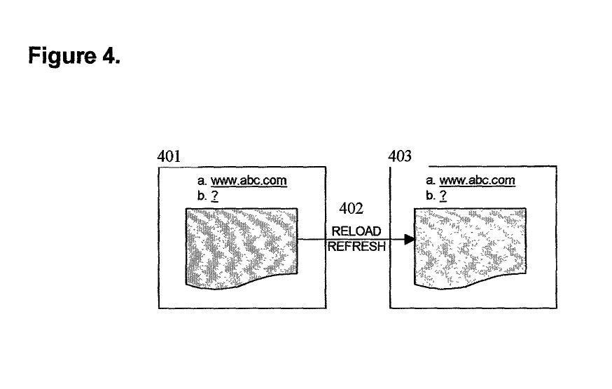

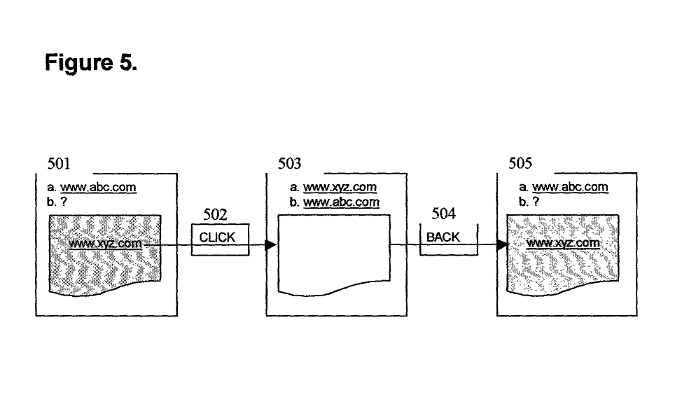

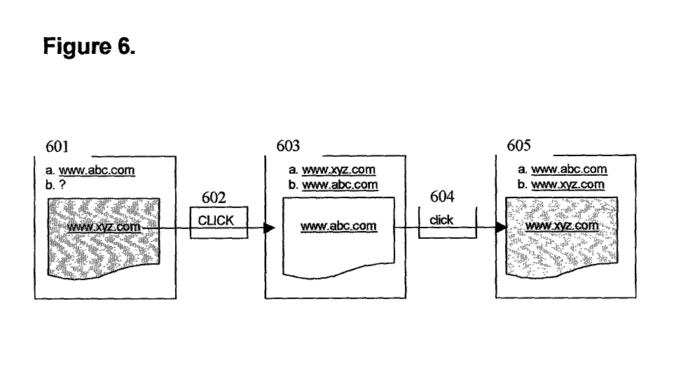

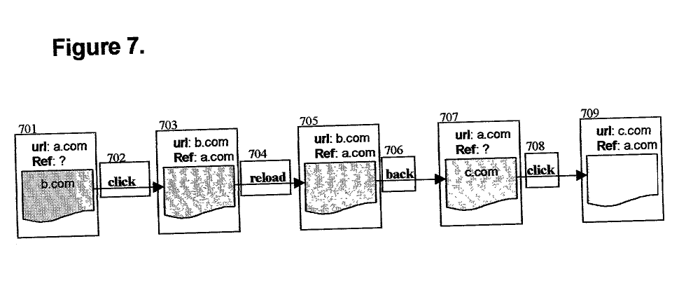

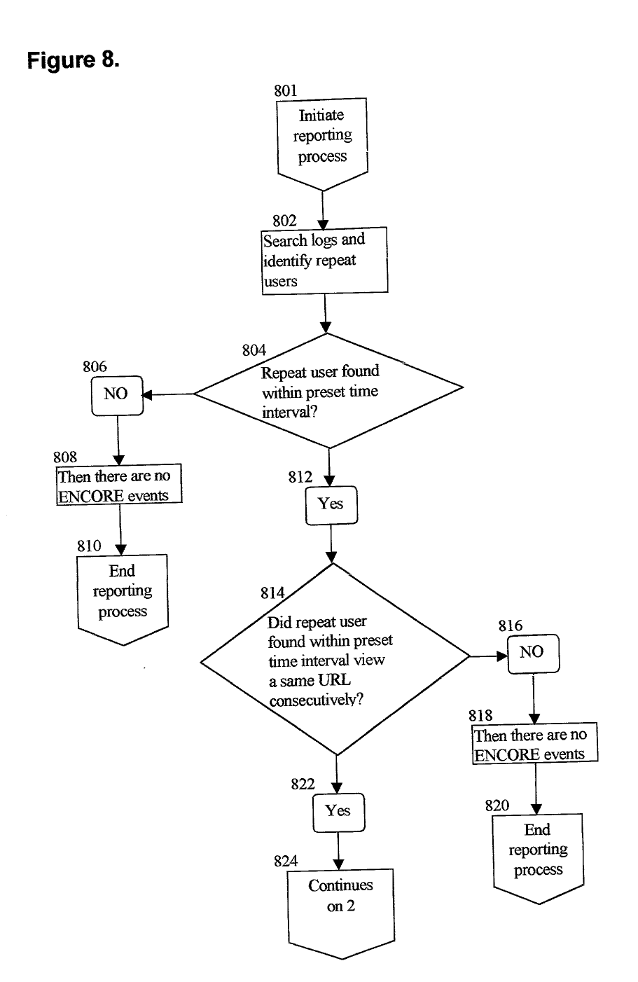

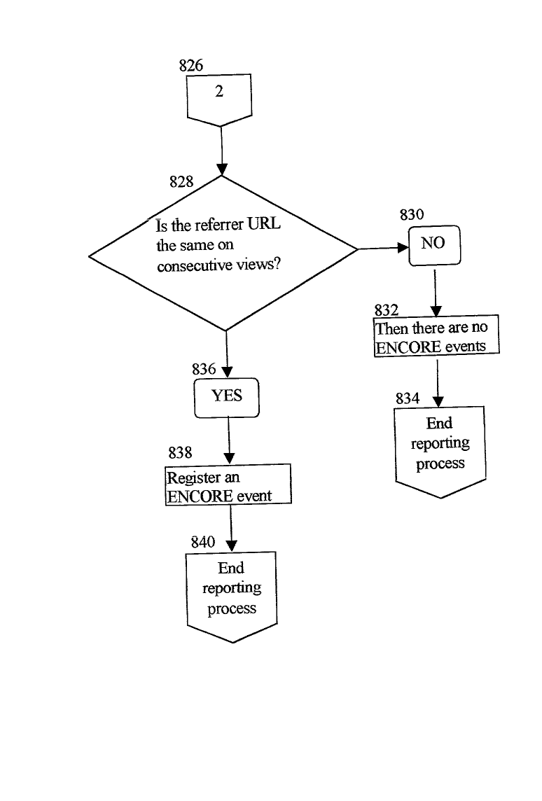

As observed in FIG. 4, the resulting pages are exactly the same, resulting in the revised hypothesis: ENCORE is when the same page is loaded more than once, regardless of the referrer.

Yet this definition is also flawed.

If we observe a how people navigate the web, we can see that it is extremely common for a user to return to a previously visited page by means of pressing the BACK button. Unfortunately for us, the BACK button behaves very similarly to the REFRESH/RELOAD buttons in that, since no link was involved, the referrer is not updated.

This results in the page being loaded using the exact same data as the first time around.

FIG. 5 shows a starting page abc.com on block 501. The user clicks on link xyz.com, (contained in page abc.com) on block 502, arriving at page xyz.com on block 503. Then the user presses the BACK button on block 504, returning to page abc.com.

When seeing page abc.com for the second time, there is no referrer, although page xyz.com was seen immediately before it. This happens because page abc.com was reached by pressing back and not by clicking on a link.

On the other hand, if page abc.com is seen for the second time not by pressing BACK but by clicking on a link, the referrer would be updated, as seen on FIG. 6.

FIG. 6, Block 601 represents page abc.com, containing a link to xyz.com. Such link is clicked on in block 602, arriving to xyz.com on block 603. Page xyz.com in turn includes a link to page abc.com, which is clicked upon on block 604, arriving at abc.com on block 605.

In order to distinguish those two occasions in which the user commands the browser to RELOAD/REFRESH a page from those in which he or she simply returns to the page for navigational purposes we can revise our definition to include only those occasions in which the same page is loaded by a unique user consecutively.

This definition is pretty accurate and would work if we could keep track of all of a user's activities on the web. But it is easy to loose track of a user's activities, which would result in inaccurate results, as depicted in the next figure.

FIG. 7 depicts the navigational path of a user surfing across 3 different web sites. Block 701 represents the original site a.com, containing a link to b.com. Block 702 shows the user clicking on such link and arriving at b.com in block 703. On block 704, the user reloads/refreshes the page, which in turn is redisplayed on block 705. After that, on block 706, the user presses the BACK button, returning to page a.com in block 707. Following, on block 708, the user clicks on a second link contained in a.com, taking him to c.com on block 709.

This described navigational route would result in data being compiled in three separate logs, one for each site.

Site A:

Recorded event 1

Page URL: A

Referrer URL: Unknown.

Site A:

Recorded event 2

Page URL: A

Referrer URL: Unknown.

Site B:

Recorded event 1

Page URL: B

Referrer URL: A

Site B:

Recorded event 2

Page URL: B

Referrer URL: A

Site C:

Recorded event 1

Page URL: C

Referrer URL: A

Studying this logs using the previous definition, we would conclude that User #1 has performed an ENCORE when viewing sites A and B, when in reality we know that it only happened in B.

This proves that the current definition is still unreliable and therefore can be further enhanced. Since the observation of all the data is impractical (there is no way to track down every user all the time) we need to an external absolute metric to aid us in our quest.

This metric is TIME.

Now that we have the final element we can go back to our original accepted definition and revise it: An ENCORE is when an unique user requests the same page consecutively within a certain given timeframe.

This timeframe is variable and depends on multiple parameters: connection speed, file size, processor, type of content . . . .

Ultimately the timeframe is the result of analyzing user behavior and can be optimized for each site or page.

FIG. 8 is a logic flow of the log analysis.

### DETAILED DESCRIPTION

The preferred embodiment of the present invention utilizes the logs kept by a third party ad server to analyze user behavior. This is done, for several reasons: first, it allows for cross-site information to be recorded. Secondly, one of the most valuable applications of the ENCORE is to gauge the success of advertisements, by measuring when users choose to see the ad again.

FIG. 8 is a logic flow of the log analysis.

The analysis/reporting process begins on block 801.

On block 802, the logs are searched looking for matching user ID numbers. Once the repeat users are found, on block 804 the frequency between occurrences is determined. If such frequency is sparser than the preset time interval, flow continues onto 806, returning a negative answer, block 808 determines that there are no Encore events and the process ends in 810.

If in block 804 it is determined that the frequency is within the preset value, then the flow continues onto 812, and on 814 the system verifies whether the repeat visitor saw the same URL consecutively.

If the answer is no, the flow continues onto 816, block 818 records the absence of ENCORE events and the process ends in block 820.

If, on the contrary, block 814 returns a positive answer, then the process goes onto 822 and follows onto the next question, found in 828. Block 828 verifies whether those consecutive views, transpiring within the preset time frame share a same referrer URL.

If the answer is negative, then it continues onto 830, then onto 832, where no ENCORE is logged and finalizes in 834.

Inversely, if the answer is positive, flow resumes in 836, block 838 notes that an ENCORE has indeed taken place and the process is completed in block 840.

What is claimed is:

1. A method for determining a user's intent to refresh or reload the contents of a web page being viewed on the display screen of a computer system, the computer system running a web browser program under an operating system having a graphical user interface, the method comprising the steps of, searching the logs of a content server, identifying unique users in such log, identifying occurrences in which the unique user views a same web page consecutively within a preset time frame.

2. A method according to claim 1, in wherein the logs belong to a party other than the one serving the content.

3. A method according to claim 1, in wherein the logs belong to an ad server party.

4. A method according to claim 1, in wherein the time frame is set dynamically based on the time spent by the average user while engaged in interacting with the current content or various other online activities.

5. A method according to claim 1, in wherein the time frame is pre set.

6. A method according to claim 1, in wherein the URL of the pages viewed by such user are utilized to determine the number of times a page is viewed.

7. A method according to claim 1, in wherein the URL of the page being viewed, as well as the URL of the page referring to the one being viewed are utilized to determine the number of times a page is viewed.

8. A method for determining a user's intent to view or review an advertisement being viewed on the display screen of a computer system, the computer system running the a web browser program under an operating system having a graphical user interface, the method comprising the steps of, searching the logs of a content server, identifying unique users in such log, identifying occurrences in which the unique user views a same web page consecutively within a preset time frame.

9. A method according to claim 8, in wherein the logs belong to a party other than the one serving the content.

10. A method according to claim 8, in wherein the logs belong to an ad server party.

11. A method according to claim 8, in wherein the time frame is set dynamically based on the time spent by the average user while engaged in interacting with the current content or various other online activities.

12. A method according to claim 8, in wherein the time frame is pre set.

13. A method according to claim 8, in wherein the URL of the pages viewed by such user are utilized to determine the number of times a user attempted to view an advertisement.

14. A method according to claim 8, in wherein the URL of the page being viewed, as well as the URL of the page referring to the one being viewed are utilized to determine the number of times a user attempted to view an advertisement.

15. A method for determining a users intent to reset content changing through time or time based content being viewed on the display screen of a computer system, the computer system running a web browser program under an operating system having a graphical user interface, the method comprising the steps of, searching the logs of a content server, identifying unique users in such logs, identifying occurrences in which the unique user views a same web page consecutively within a preset time frame.

16. A method according to claim 15, in wherein the logs belong to a party other than the one serving the content.

17. A method according to claim 15, in wherein the logs belong to an ad server party.

18. A method according to claim 15, in wherein the time frame is set dynamically based on the time spent by the average user while engaged in interacting with the current content or various other online activities.

19. A method according to claim 15, in wherein the time frame is pre set.

20. A method according to claim 15, in wherein the URL of the pages viewed by such user are utilized to determine the number of times a page is viewed.

21. A method according to claim 15, in wherein the URL of the page being viewed, as well as the URL of the page referring to the one being viewed are utilized to determine the number of times a page is viewed.

22. A method for determining a user's intent to refresh or reload content being viewed on the display screen of an interactive television system, such system being capable of delivering custom content to each individual user or group of users, the method comprising the steps of, searching the logs of a content server, identifying unique users in such log, identifying occurrences in which the unique user views the same content consecutively within a preset time frame.

23. A method according to claim 22, in wherein the logs belong to a party other than the one serving the content.

24. A method according to claim 22, in wherein the logs belong to an ad server party.

25. A method according to claim 22, in wherein the time frame is set dynamically based on the time spent by the average user while engaged in interacting with the current content or various other online activities.

26. A method according to claim 22, in wherein the time frame is pre set.

27. A method for determining a users intent to view or review an advertisement being viewed on the display screen of an interactive television system, such system being capable of delivering custom content to each individual user or group of users, the method comprising the steps of, searching the logs of a content server, identifying unique users in such log, identifying occurrences in which the unique user views the same content consecutively within a preset time frame.

28. A method according to claim 27, in wherein the logs belong to a party other than the one serving the content.

29. A method according to claim 27, in wherein the logs belong to an ad server party.

30. A method according to claim 27, in wherein the time frame is set dynamically based on the time spent by the average user while engaged in interacting with the current content or various other online activities.

31. A method according to claim 27, in wherein the time frame is pre set.

32. A method for determining a user's intent to reset content changing through time being viewed on the display screen of an interactive television system, such system being capable of delivering custom content to each individual user or group of users, the method comprising the steps of, searching the logs of a content server, identifying unique users in such log, identifying occurrences in which the unique user views the same content consecutively within a preset time frame.

33. A method according to claim 32, in wherein the logs belong to a party other than the one serving the content.

34. A method according to claim 32, in wherein the logs belong to an ad server party.

35. A method according to claim 32, in wherein the time frame is set dynamically based on the time spent by the average user while engaged in interacting with the current content or various other online activities.

36. A method according to claim 32, in wherein the time frame is pre set.
